(19) United States
(12) Patent Application Publication
(10) Pub. No.: US 2026/0110983 A1
(43) Pub. Date: Apr. 23, 2026

(54) FIXING DEVICE AND IMAGE FORMING APPARATUS

(71) Applicants: Yuma MATSUMOTO, Kanagawa (JP); Yuusuke FURUICHI, Kanagawa (JP)

(72) Inventors: Yuma MATSUMOTO, Kanagawa (JP); Yuusuke FURUICHI, Kanagawa (JP)

(21) Appl. No.: 19/348,826

(22) Filed: Oct. 3, 2025

(30) Foreign Application Priority Data
Oct. 19, 2024 (JP) 2024-184491

(51) Int. Cl. G03G 15/20

(52) U.S. Cl. CPC G03G 15/2053; G03G 15/2064; G03G 2215/2025

(57) ABSTRACT

A fixing device includes a fixing rotator, a pressing rotator, and a conductive roller.

The fixing rotator includes a heat source. The pressing rotator is pressed against the fixing rotator to form a nip portion between the pressing rotator and the fixing rotator to perform a fixing process. The conductive roller has conductivity and contacting the pressing rotator. The fixing rotator includes a first conductive layer and an insulating layer. The first conductive layer has conductivity. The insulating layer is on the first conductive layer and has insulating property. The pressing rotator includes a second conductive layer and conductor. The second conductive layer has conductivity and contacts the insulating layer of the fixing rotator. The conductor is grounded and electrically connected to the first conductive layer.

The conductive roller contacts each of the second conductive layer and the conductor to electrically connect the second conductive layer and the conductor.

### CROSS-REFERENCE TO RELATED APPLICATION

This patent application is based on and claims priority pursuant to 35 U.S.C. § 119(a) to Japanese Patent Application No. 2024-184491, filed on Oct. 19, 2024, in the Japan Patent Office, the entire disclosure of which is hereby incorporated by reference herein.

### BACKGROUND

### Technical Field

The present disclosure relates to a fixing device that heats a toner image borne on a surface of a sheet, and an image forming apparatus such as a copier, a printer, a facsimile, or a multifunction peripheral thereof including the fixing device.

### Related Art

In a fixing device installed in an image forming apparatus such as a copier or a printer, a technique is known that static electricity of a fixing rotator such as a fixing belt or a fixing roller and a pressing rotator such as a pressure roller is eliminated by using a static eliminating brush in order to prevent occurrence of an abnormal image such as electrostatic offset.

### SUMMARY

The present disclosure described herein provides a fixing device that includes a fixing rotator, a pressing rotator, and a conductive roller. The fixing rotator includes a heat source in the fixing rotator. The pressing rotator is pressed against the fixing rotator to form a nip portion between the pressing rotator and the fixing rotator to perform a fixing process. The conductive roller has conductivity and contacting the pressing rotator. The fixing rotator includes a first conductive layer and an insulating layer. The first conductive layer has conductivity. The insulating layer is on the first conductive layer and has insulating property. The pressing rotator includes a second conductive layer and conductor. The second conductive layer has conductivity and contacts the insulating layer of the fixing rotator to form the nip portion. The conductor is grounded and electrically connected to the first conductive layer of the fixing rotator. The conductive roller contacts each of the second conductive layer and the conductor to electrically connect the second conductive layer and the conductor.

The present disclosure described herein also provides an image forming apparatus that includes a process cartridge and the fixing device. The process cartridge forms an image on a sheet. The fixing device fixes the image formed on the sheet by the process cartridge.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a schematic view of a fixing device of the image forming apparatus of FIG. 1;

FIG. 3 is a top view of the fixing device of FIG. 2, viewed in a width direction;

FIG. 4 is a side view of a fixing belt and a guide of the fixing device of FIG. 3, viewed in a width direction;

FIG. 5 is a diagram illustrating a fixing device in a state where a conductive roller is in contact with a target portion;

FIG. 6 is a diagram illustrating the fixing device in a state where the conductive roller is separated from the target portion;

FIG. 7 is a flowchart of a contact-and-separation control of the conductive roller;

FIG. 8 is a flowchart of a contact-and-separation control of a conductive roller according to a first modification; and

FIG. 9 is a diagram illustrating a fixing device in a state where a conductive roller is in contact with a target portion according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical reference numerals are assigned to identical or equivalent components and a description of those components may be simplified or omitted. As used herein, the singular forms “a,” “an,” and “the” are intended to include the plural forms as well, unless the context clearly indicates otherwise.

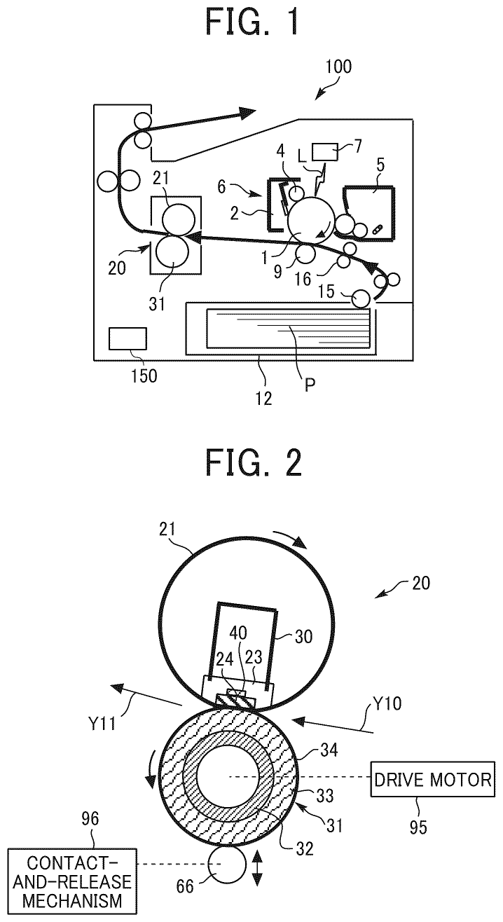

With reference to FIG. 1, a description is given of an overall configuration and operation of an image forming apparatus 100 according to an embodiment of the present disclosure. In FIG. 1, the image forming apparatus 100 that is a small printer in the present embodiment includes a photoconductor drum 1 on which a toner image is formed, a process cartridge 6 in which the photoconductor drum 1, a charging roller 4, a developing device 5, and a cleaning device 2 are united, and an exposure device 7 (a writing device) that irradiates the photoconductor drum 1 with exposure light L based on image data input from an input device such as a personal computer. The image forming apparatus 100 further includes a transfer roller 9 that transfers the toner image borne on the surface of the photoconductor drum 1 onto a sheet P conveyed to a transfer nip (transfer position), a sheet feeder 12 (sheet tray) that stores the sheet P such as paper, a registration roller pair 16 (timing roller) that conveys the sheet P toward the transfer nip where the photoconductor drum 1 and the transfer roller 9 contact against each other, and a fixing device 20 that fixes an unfixed image on the sheet P.

The charging roller 4, the developing device 5, and the cleaning device 2 are arranged around the photoconductor drum 1. These components (the photoconductor drum 1, the charging roller 4, the developing device 5, and the cleaning device 2) are united as the process cartridge 6, and are removably (replaceably) installed to a body of the image forming apparatus 100 (apparatus body). After the process cartridge 6 are used for a specified replacement cycle, a user removes the process cartridge 6 from the body of the image forming apparatus 100 and replaces the process cartridge 6 with a new one.

With reference to FIG. 1, a description is given of a normal operation of the image forming apparatus 100 below. As image data is transmitted from the input device, such as a personal computer, to the exposure device 7 in the image forming apparatus 100, the exposure device 7 irradiates the surface of the photoconductor drum 1 with exposure light L (laser beam) according to the image data. The photoconductor drum 1 is driven to rotate by a drive motor disposed in the body of the image forming apparatus 100 in the direction indicated by the arrow in FIG. 1 (clockwise). First, the charging roller 4 uniformly charges the surface of the photoconductor drum 1 at a position at which the surface of the photoconductor drum 1 faces the charging roller 4 (in a charging process). As a result, a charging potential (for example, approximately −900 V) is formed on the surface of the photoconductor drum 1.

The charged surface of the photoconductor drum 1 thereafter reaches an irradiation position of the exposure light L. An irradiated portion of the photoconductor drum 1 irradiated with the exposure light L has a latent image potential (from about 0 to −100 V), and thus an electrostatic latent image is formed on the surface of the photoconductor drum 1 (in an exposure process).

The surface of the photoconductor drum 1 bearing the electrostatic latent image thereon rotates until the surface of the photoconductor drum 1 reaches a position opposite the developing device 5. The developing device 5 supplies toner onto the photoconductor drum 1, thereby developing the latent image formed on the photoconductor drum 1 into the toner image (in a developing process). After the developing process, the surface of the photoconductor drum 1 bearing the toner image thereon reaches the transfer nip (transfer position) between the photoconductor drum 1 and the transfer roller 9. In the transfer nip between the photoconductor drum 1 and the transfer roller 9, a transfer bias having a polarity opposite the polarity of the toner is applied from a power supply to the transfer roller 9, thereby transferring the toner image formed on the photoconductor drum 1 onto the sheet P conveyed by a registration roller pair 16 (in a transfer process).

The surface of the photoconductor drum 1 after the transfer process reaches a position opposite the cleaning device 2. At this position, untransferred toner remaining on the surface of the photoconductor drum 1 is mechanically removed by a cleaning blade and collected in the cleaning device 2 (in a cleaning process). Thus, a series of image forming processes on the photoconductor drum 1 is completed.

The sheet P is conveyed to the transfer nip between the photoconductor drum 1 and the transfer roller 9 as follows. First, a feed roller 15 feeds the uppermost sheet P of the stack of sheets P stored in the sheet feeder 12 toward a conveyance passage. Thereafter, the sheet P reaches the position of the registration roller pair 16. The sheet P that has reached the position of the registration roller pair 16 is conveyed to the transfer nip (the contact position of the transfer roller 9 and the photoconductor drum 1) at a timing at which the sheet P can receive the toner image formed on the photoconductor drum 1.

After the transfer process, the sheet P passes through the transfer nip (the position of the transfer roller 9) and reaches the fixing device 20 through the conveyance passage. In the fixing device 20, the sheet P is conveyed between a fixing belt 21 and a pressure roller 31, so that the toner image is fixed onto the sheet P under heat applied by the fixing belt 21 and pressure applied by the contact of the fixing belt 21 and the pressure roller 31 (in a fixing process). After the sheet P having the fixed toner image thereon ejected from the fixing nip formed between the fixing belt 21 and the pressure roller 31, the sheets P are ejected from the body of the image forming apparatus 100 and stacked on an output tray. Thus, a series of the image forming processes is completed.

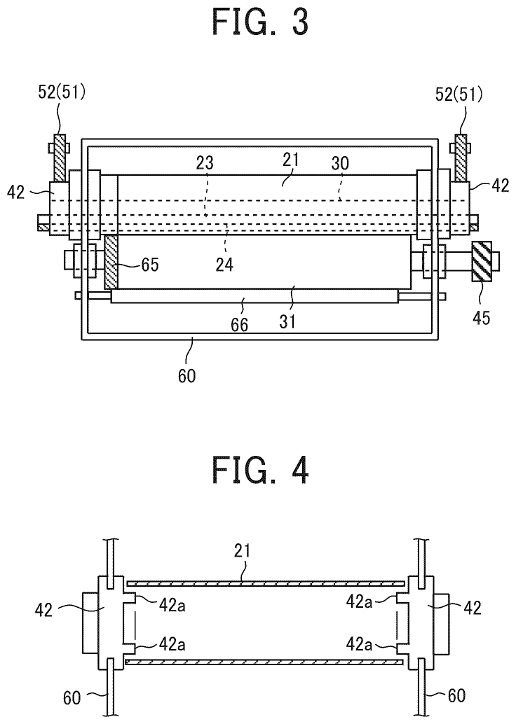

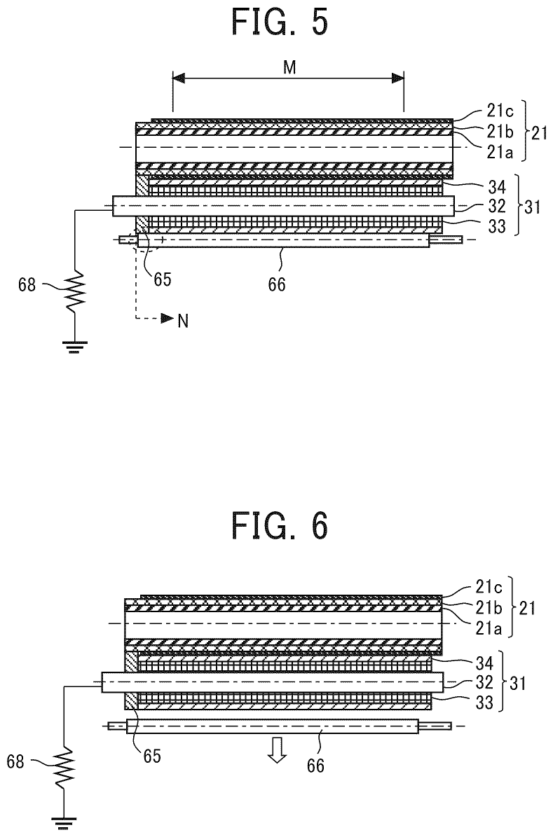

With reference to FIGS. 2 to 6, a description is given of a configuration and operation of the fixing device 20. The fixing device 20 conveys the sheet P bearing an unfixed toner image while heating the sheet P. With reference to FIG. 2, the fixing device 20 includes the fixing belt 21 as a fixing rotator, a planar heater 24 as a heat source (heater), a holder 23, a stay 30, a thermistor 40, the pressure roller 31 as a pressing rotator, a conductive roller 66, and a conductor 65 (see FIGS. 3 and 5).

The fixing belt 21 as the fixing rotator is an endless belt that contacts an outer circumferential surface of the pressure roller 31 and is driven to rotate by rotation of the pressure roller 31. The fixing belt 21 is a thin and flexible endless belt driven to rotate in a rotation direction indicated by an arrow (clockwise) in FIG. 2. With reference to FIG. 5, which is not to scale, the fixing belt 21 includes a base layer 21a, a conductive elastic layer 21b as a conductive layer, and an insulating surface layer 21c that are sequentially laminated from the inner circumferential surface (the surface that slides to contact the planar heater 24), and then, the total thickness of the fixing belt 21 is set to 1 mm or less. The base layer 21a of the fixing belt 21 has a thickness of 30 to 50 μm and is made of metal, such as nickel or stainless steel, or resin such as polyimide. The conductive elastic layer 21b of the fixing belt 21 has a thickness of 100 to 300 μm, is formed by dispersing, for example, carbon in a rubber material such as silicone rubber, foamed silicone rubber, or fluororubber, and has conductivity. The conductive elastic layer 21b absorbs slight surface asperities of the fixing belt 21 at a fixing nip formed between the fixing belt 21 and the pressure roller 31, facilitating even heat conduction from the fixing belt 21 to the toner image on the sheet P and thereby preventing occurrence of an orange peel image on the sheet P. The insulating surface layer 21c of the fixing belt 21 has a thickness of 5 to 50 μm and is made of an insulating material such as tetrafluoroethylene-perfluoroalkyl vinyl ether copolymer (PFA), polytetrafluoroethylene (PTFE), polyimide, polyether imide, and polyether sulfone (PES). The insulating surface layer 21c facilitates releasability (peelability) for toner (toner image) on the sheet P.

The planar heater 24, the holder 23, the stay 30, and the thermistor 40 are disposed inside (on the side of the inner circumferential surface) the fixing belt 21. The planar heater 24 is disposed to extend in a width direction (the direction perpendicular to the plane on which FIG. 2 is illustrated). The planar heater 24 contacts the inner circumferential surface of the fixing belt 21. The planar heater 24 is pressed against the pressure roller 31 via the fixing belt 21 to form the fixing nip through which the sheet P is conveyed. The planar heater 24 is disposed to slide and contact the inner circumferential surface of the fixing belt 21. The planar heater 24 is pressed against the pressure roller 31 via the fixing belt 21 to form the fixing nip through which the sheet P is conveyed. As described above, the planar heater 24 functions as a nip formation pad that is a member forming the fixing nip. The planar heater 24 may include a surface layer or a sheet made of a low friction material such as PTFE on the surface of the planar heater 24 to reduce sliding friction between the fixing belt 21 and the planar heater 24. The planar heater 24 includes a resistor pattern (that is, a heating resistor) formed on a portion that slides and contacts an inner circumferential surface of the fixing belt 21. A power supply supplies electric power to the resistor pattern, and the resistor pattern generates heat due to the resistance of the resistor pattern to heat the fixing belt 21. As described above, the planar heater 24 also functions as a heat source (heater) to heat the fixing belt 21.

In the present embodiment, the planar heater 24 is held by the holder 23.

The holder 23 has a recess. The planar heater 24 is fitted into the recess to hold the planar heater 24 across the width direction. The holder 23 is held by the stay 30 while holding the planar heater 24. Both ends in the width direction of the stay 30 holding the planar heater 24 and the holder 23 is held by a frame 60 of the fixing device 20 via flanges 42 (see FIG. 3).

As described above, the fixing belt 21 is directly heated by the planar heater 24 (the resistor pattern) disposed inside the fixing belt 21. The outer circumferential surface of the fixing belt 21 heated by the planar heater 24 heats the toner image on the sheet P. Output control of the planar heater 24 is performed based on a detection result of the temperature of the planar heater 24 detected by the thermistor 40. The thermistor 40 directly contacts the planar heater 24 (or indirectly contacts the planar heater 24 via another member). In the present embodiment, the fixing device 20 does not include a temperature sensor that directly detects the surface temperature of the fixing belt 21. The temperature of the planar heater 24 is controlled by the thermistor 40 to indirectly control the surface temperature (that is, a fixing temperature) of the fixing belt 21 to be the desired temperature.

With reference to FIG. 4, a pair of flanges 42 guide ends of the inner circumferential surface of the fixing belt 21 in the width direction of the fixing belt 21 such that the fixing belt 21 maintains a substantially cylindrical posture. Specifically, the two flanges 42 are made of a heat-resistant resin material and are held by both sides of the frame 60 in the width direction of the frame 60 of the fixing device 20 so that each of the flanges 42 can slide and move along each of the sides of the frame 60 in a direction in which the fixing nip is formed. Each of the flanges 42 includes a guide 42a and a stopper. The guides 42a hold the fixing belt 21 to maintain the substantially cylindrical posture of the fixing belt 21. The stopper restricts movement or skew of the fixing belt 21 in the width direction of the fixing belt 21. As illustrated in FIG. 3, the fixing device 20 includes pressing levers 52 (pressing devices 51). The pressing levers press the flanges 42 such that the fixing belt 21 (the planar heater 24 and the holder 23) press the pressure roller 31. The flanges 42 are disposed at both ends, that is a circumferential region excluding the fixing nip not to hinder formation of the fixing nip by the planar heater 24. In the present embodiment, a component that contacts the inner circumferential surface of the fixing belt 21 is the flanges 42 that loosely contact at the both ends in the width direction and the planar heater 24. There is no other member that contacts the inner circumferential surface of the fixing belt 21 to guide the rotation of fixing belt 21, such as a belt guide.

In the present embodiment, the fixing device 20 includes the stay 30 that is disposed inside the fixing belt 21 to contact the pressure roller 31 via the planar heater 24 (the holder 23) and the fixing belt 21. The stay 30 reinforces the mechanical strength of the planar heater 24 (and the holder 23) that forms the fixing nip, and is installed to the frame 60 (or the holder 23) by, for example, screw fastening. The stay 30 contacts the pressure roller 31 via the planar heater 24 (and the holder 23) and the fixing belt 21 to prevent the planar heater 24 (and the holder 23) from largely deforming by receiving the pressure from the pressure roller 31 at the fixing nip. Preferably, the stay 30 is made of metal having high mechanical strength, such as stainless steel or iron, to satisfy the above-described function.

The holder 23 may be made of resin or metal. Preferably, the holder 23 is made of resin that has rigidity to prevent the holder 23 from bending even if the holder 23 receives pressure from the pressure roller 31, and has heat resistance and thermal insulation. The resin may be, for example, liquid crystal polymer (LCP), polyamide imide (PAI), polyether sulfone (PES), polyphenylene sulfide (PPS), polyether nitrile (PEN), and polyether ether ketone (PEEK). The holder 23 according to the present embodiment is made of liquid crystal polymer (LCP).

With reference to FIG. 2, the pressure roller 31 as the pressing rotator includes a cored bar 32 serving as a shaft extending in the axial direction, an elastic layer 33 layered on the cored bar 32, and a conductive surface layer 34 layered on the elastic layer 33. The pressure roller 31 is driven to rotate counterclockwise in FIG. 2 by a drive motor 95. The cored bar 32 of the pressure roller 31 has a hollow structure made of metal (conductive material). The elastic layer 33 of the pressure roller 31 is made of an insulating material such as silicone rubber foam, silicone rubber, or fluororubber. The conductive surface layer 34 of the pressure roller 31 is a thin surface layer (a release layer). The conductive surface layer 34 is made of PFA or PTFE in which carbon is dispersed to have conductivity. The pressure roller 31 is pressed against the fixing belt 21 to form a desired nip (the fixing nip) between the pressure roller 31 and the fixing belt 21. As illustrated in FIG. 3, a gear 45 meshes a driving gear of the drive motor is attached to the pressure roller 31 so that the pressure roller 31 is driven to rotate in a direction indicated by the arrow in FIG. 2 (counterclockwise). Both ends of the pressure roller 31 in the width direction are rotatably supported by the frame 60 of the fixing device 20 via bearings. The fixing device 20 according to the present embodiment also includes the conductive roller 66 and the conductor 65, which are described in detail below.

A description is given of a regular fixing operation of the fixing device 20 having the configuration described above. When a power switch of the body of the image forming apparatus 100 is turned on, electric power is supplied to the planar heater 24, and the pressure roller 31 is started driving to rotate by the drive motor 95 in the direction indicated by the arrow in FIG. 2 (clockwise). With such a configuration, due to friction force between the fixing belt 21 and the pressure roller 31 at the fixing nip, the fixing belt 21 is also driven by the pressure roller 31 to rotate in a direction indicated by the arrow in FIG. 2. After the fixing belt 21 rotates, the sheet P is fed from the sheet feeder 12, and an unfixed toner image is borne (transferred) onto the sheet P at the position of the transfer roller 9. As illustrated in FIG. 2, the sheet P bearing the unfixed image (toner image) is conveyed in a direction indicated by an arrow Y10 while the sheet P is guided by an entrance guide plate, and enters the nip portion (fixing nip) formed between the fixing belt 21 and the pressure roller 31, which are pressed against each other. The planar heater 24 heats the fixing belt 21. The planar heater 24 (the holder 23) is reinforced by the stay 30. The heat from the fixing belt 21 and the pressure between the planar heater 24 and the pressure roller 31 fix the toner image on the surface of the sheet P. After the toner image is fixed on the surface of the sheet P, the sheet P sent out from the fixing nip is conveyed in a direction indicated by an arrow Y11 in FIG. 2 while the sheet P is guided by an exit guide plate.

A description is given of a configuration and operation of the fixing device 20 of the image forming apparatus 100 according to the present embodiment in detail below. As described above with reference to FIGS. 2 and 5, the fixing belt 21 serving as a fixing rotator includes the conductive elastic layer 21b serving as a conductive layer having conductivity. The insulating surface layer 21c having insulating properties is directly layered on the conductive elastic layer 21b (conductive layer) in the fixing belt 21. Specifically, in the present embodiment, one end of the conductive elastic layer 21b in the width direction (the side on which the conductor 65 described later is disposed, and the left in FIG. 5) is formed to protrude toward the one end in the width direction from the insulating surface layer 21c. The pressure roller 31 as the pressing rotator includes the conductive surface layer 34 that has the conductivity. The conductive surface layer 34 contacts the insulating surface layer 21c of the fixing belt 21 (fixing rotator) to form the nip portion (fixing nip).

The pressure roller 31 (pressing rotator) of the fixing device 20 according to the present embodiment includes the conductor 65 that is electrically connected to the conductive elastic layer 21b (conductive layer) of the fixing belt 21 (fixing rotator) and is grounded. Specifically, as illustrated in FIG. 5, the conductor 65 is a doughnut-shaped (circular) member made of a conductive material, and is inserted into the cored bar 32 (a portion that function a shaft portion at an end) of the pressure roller 31 to contact the of the conductive elastic layer 21b (conductive layer) of the fixing belt 21. In the present embodiment, the conductor 65 is press-fitted into the cored bar 32 in order to enhance the conductivity (electrical connectivity) with the cored bar 32.

In the present embodiment, the conductor 65 has an outer diameter substantially equal to or slightly larger than the outer diameter of a roller body (a portion where the elastic layer 33 and the conductive surface layer 34 are formed) of the pressure roller 31. The conductor 65 contacts the conductive elastic layer 21b (a portion protruding toward one end in a width direction) of the fixing belt 21. At this time, even if the outer diameters of the conductor 65 and the roller main portion are the same, the conductor 65 contacts the conductive elastic layer 21b and is electrically connected thereto because the insulating surface layer 21c is very thin and the pressure roller 31 is pressed against the fixing belt 21 to push into the fixing belt 21. Although not illustrated in FIG. 5, the conductive elastic layer 21b contacts the conductor 65 to be nipped between the conductor 65 and the flange 42 (see FIGS. 3 and 4). The conductor 65 is installed such that an end surface thereof is in close contact with an end surface of the roller main portion (a portion where the elastic layer 33 and the conductive surface layer 34 are formed) of the pressure roller 31 without a gap. Such a configuration can reduce the size in the width direction without forming a gap between the conductor 65 and the roller main portion (the elastic layer 33 and the conductive surface layer 34).

As illustrated in FIG. 5, the conductor 65 according to present embodiment is grounded (earthed) via the cored bar 32. Specifically, the cored bar 32 is connected to a grounding wire (which is connected to the frame 60 that is grounded) via a resistor 68 (an electric resistance member). Such a configuration allows the conductor 65 to be grounded well. The conductor 65 is disposed outside a maximum sheet conveyance region M (in other words, disposed in a non-sheet conveyance region) in the fixing device 20. The maximum sheet conveyance region M is defined as a region in the width direction through which a sheet P having a maximum size that can be conveyed passes. As a result, the conductor 65 does not contact the fixed image.

As illustrated in FIGS. 3 and 5, the fixing device 20 according to the present embodiment includes the conductive roller 66 that contacts to be electrically connected to the conductive surface layer 34 of the pressure roller 31 (pressing rotator) and the conductor 65. Specifically, at least the surface of the conductive roller 66 is made of a conductive material. The conductive roller 66 contacts the conductor 65 and the conductive surface layer 34 across the width direction. In other words, the conductive roller 66 contacts the outer circumferential surface of the roller main portion (conductive surface layer 34) of the pressure roller 31 and the outer circumferential surface of the conductor 65. With such a configuration, the conductor 65 and the conductive surface layer 34 are electrically connected to each other via the conductive roller 66. In particular, as described above, the conductor 65 is in close contact with the end surface of the conductive surface layer 34, and thus is electrically connected thereto by the contact. However, the conductivity thereof is low because the conductor 65 is a thin layer. In the present embodiment, the conductive roller 66 contacts the outer circumferential surface of the conductive surface layer 34 and the outer circumferential surface of the conductor 65, and thus the conductivity becomes stronger. The conductor 65 is also strongly electrically connected to the conductive elastic layer 21b (conductive layer) of the fixing belt 21, and is grounded via the cored bar 32. The conductive roller 66 is rotated by the rotation of the pressure roller 31.

As described above, the fixing device 20 according to the present embodiment includes the conductor 65 and the conductive roller 66. Thus, the conductive elastic layer 21b of the fixing belt 21 and the conductive surface layer 34 of the pressure roller 31 are preferably electrically connected to the conductor 65 that is grounded. Accordingly, the above-described structure is less likely to accumulate electric charge in the fixing belt 21 and the pressure roller 31, and reduces the occurrence of an abnormal image such as an electrostatic offset caused by the electric charge accumulation. In particular, in the present embodiment, the conductive roller 66 is disposed to straddle the conductor 65 and the conductive surface layer 34. Thus, the disadvantage that the charge elimination effect is reduced or abnormal images occur due to falling off or settling of brush bristles as in the case of using a charge elimination brush. In other words, the electric charge is less likely to be accumulated in the fixing belt 21 and the pressure roller 31 even over time. Thus, the occurrence of the abnormal image such as the electrostatic offset can be stably reduced.

The electrostatic offset occurs as follows in the fixing process. Toner borne on the sheet P that is sent to the fixing nip electrostatically moves and adheres to the fixing belt 21 as the fixing rotator. After the fixing belt 21 rotates once, the toner adhered to the fixing belt 21 adheres to the sheet P again. The above-described movement of toner to the fixing belt 21 is caused by charge on the surfaces of the fixing belt 21 and the pressure roller 31. In the present embodiment, the toner is negatively charged. When the fixing belt 21 is positively charged and the pressure roller 31 is negatively charged, the toner that has received an electrostatic repulsive force from the pressure roller 31 and an electrostatic adsorptive force from the fixing belt 21. Thus, the toner adheres to the fixing belt 21. For the above-described phenomenon, in the fixing device 20 according to the present embodiment, the electrostatic charge is actively eliminated from the conductive elastic layer 21b of the fixing belt 21 and the conductive surface layer 34 of the pressure roller 31 as described above. As a result, the surfaces of the fixing belt 21 and the pressure roller 31 are less likely to be charged. As a result, electrostatic offset is less likely to occur.

With reference to FIGS. 5 and 6, in the present embodiment, the conductive roller 66 is contactable with and separatable from the conductor 65 and the conductive surface layer 34. In other words, the conductive roller 66 is contactable with and separatable from the pressure roller 31. Specifically, with reference to FIGS. 1 and 2, the conductive roller 66 is connected to a contact-and-separation mechanism 96 including a cam mechanism controlled by a controller 150 in FIG. 1. The conductive roller 66 is controlled to contact the conductor 65 and the conductive surface layer 34 as illustrated in FIG. 5 during the fixing step (during printing), and to be separated from the conductor 65 and the conductive surface layer 34 as illustrated in FIG. 6 during the non-fixing step (during non-printing).

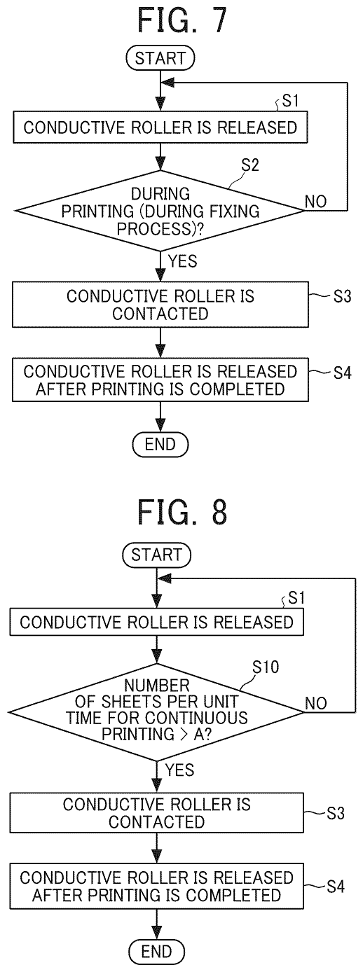

Specifically, as illustrated in the flowchart of FIG. 7, first, when the image forming apparatus 100 is out of operation or is idling (driven without printing) such as during warm-up, the conductive roller 66 is in a separated state (the state of FIG. 6) as a default state (in step S1). When it is determined whether printing is being performed (in step S2), and when it is determined that printing has been started, the contact-and-separation mechanism 96 is controlled to shift the conductive roller 66 to the contact state (the state illustrated in FIG. 5) (in step S3). When the printing is completed, the contact-and-separation mechanism 96 is controlled to shift the conductive roller 66 to the separated state (the state illustrated in FIG. 6) again (in step S4).

As described above, the conductive roller 66 is in contact state during printing in which electrostatic offset may occur, the time during which the conductive roller 66 is brought into contact with the pressure roller 31 in vain can be reduced. As a result, the wear deterioration of the conductive roller 66 and the pressure roller 31 can be reduced.

As illustrated in FIG. 5, in the present embodiment, the conductive roller 66 contacts the conductor 65 and the conductive surface layer 34 at a position where the conductive roller 66 does not protrude outward in the width direction (the left in FIG. 5) with respect to the conductor 65. In other words, the conductive roller 66 (which is a roller portion that actually contacts the conductor 65 and the conductive surface layer 34) is disposed within a region N illustrated in FIG. 5. With such a configuration, a disadvantage that the conductive roller 66 contacts an edge portion of the conductor 65 and a gap (a clearance) is generated in the vicinity of the edge portion, or a disadvantage that the roller surface is likely to be easily damaged can be prevented. In the present embodiment, the conductive roller 66 (which is a roller portion that actually contacts the conductor 65 and the conductive surface layer 34) is formed from one end in the width direction (the left in FIG. 5) to the other end in the width direction (the right in FIG. 5), and thus, the contact pressure received by the pressure roller 31 can be made uniform over the width direction.

### First Modification

As illustrated in the flowchart of FIG. 8, in the fixing device 20 according to the first modification, the conductive roller 66 is controlled to contact the conductor 65 and the conductive surface layer 34 as illustrated in FIG. 5 when the sheets P are continuously conveyed to the nip portion (fixing nip) (during continuous printing) and the number of sheets P continuously conveyed per unit time exceeds a specified number A, and to be separated from the conductor 65 and the conductive surface layer 34 as illustrated in FIG. 6 when the number of sheets per unit time does not exceed the specified number A. Specifically, as illustrated in FIG. 8, first, when the image forming apparatus 100 is out of operation or is idling (driven without printing) such as during warm-up, the conductive roller 66 is in a separated state (the state of FIG. 6) as a default state (in step S1). Then, it is determined whether the continuous printing in which the number of printed sheets per unit time exceeds the specified number A is performed (in step S10), and when it is determined that the continuous printing in which the number of printed sheets per unit time exceeds the specified number A has been started, the contact-and-separation mechanism 96 is controlled to shift the conductive roller 66 to the contact state (the state illustrated in FIG. 5) (in step S3). When the printing is completed, the contact-and-separation mechanism 96 is controlled to shift the conductive roller 66 to the separated state (the state illustrated in FIG. 6) again (in step S4).

The reason why such control is performed is that the electrostatic offset is likely to occur during continuous printing, and particularly, during continuous printing in which the number of printed sheets per unit time is large. Then, when the electrostatic offset is likely to occur, the conductive roller 66 is in the contact state, the time during which the conductive roller 66 wastefully contacts the pressure roller 31 can be reduced. As a result, the wear deterioration of the conductive roller 66 and the pressure roller 31 can be reduced. Such control is useful in a case of an apparatus that is variable of a sheet conveyance speed (the number of printed sheets per unit time) during continuous printing. For example, the fixing device 20 is set to a slow-speed mode in which the fixing device 20 can continuously print an image on a sheet P at a sheet conveyance speed slower than a normal sheet conveyance speed so that the fixing temperature of the fixing belt 21 is not likely to decrease during the continuous printing.

### Second Modification

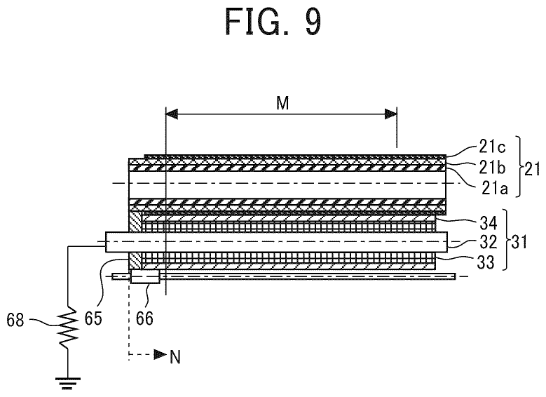

As illustrated in FIG. 9, in the fixing device 20 according to a second modification, the conductive roller 66 (which is a roller portion that actually contacts the conductor 65 and the conductive surface layer 34) is formed on one end in the width direction (the left in FIG. 9) having a shorter size in the width direction than the size illustrated in FIG. 5, and contacts the conductor 65 and the conductive surface layer 34 outside the maximum sheet conveyance region M (non-sheet conveyance region). With such a configuration, the conductive roller 66 does not contact the maximum sheet conveyance region M of the pressure roller 31 (the conductive surface layer 34). Thus, even if wear deterioration occurs in the contact portion of the pressure roller 31 with the conductive roller 66, the wear deterioration does not affect the fixed image. As illustrated in FIG. 9, also in the present embodiment, the conductive roller 66 contacts the conductor 65 and the conductive surface layer 34 at a position where the conductive roller 66 does not protrude outward in the width direction (the left in FIG. 9) with respect to the conductor 65. With such a configuration, a disadvantage that the conductive roller 66 contacts an edge portion of the conductor 65 and a gap (a clearance) is generated in the vicinity of the edge portion, or a disadvantage that the roller surface is likely to be damaged can be prevented.

As described above, the fixing device 20 in the present embodiment includes the fixing belt 21 (fixing rotator) heated by the planar heater 24 (heat source) and the pressure roller 31 (pressing rotator) that is pressed and contacted against the fixing belt 21 to form the nip portion where the sheet P is conveyed. The fixing belt 21 includes the conductive elastic layer 21b (conductive layer) having conductivity and the insulating surface layer 21c directly or indirectly layered on the conductive elastic layer 21b and having insulating property. The pressure roller 31 includes a conductive surface layer 34 that contacts the insulating surface layer 21c of the fixing belt 21 to form a nip portion, and a conductor 65 that is electrically connected to the conductive elastic layer 21b of the fixing belt 21 and is grounded. The pressure roller 31 includes the conductive roller 66 that contacts the conductive surface layer 34 of the pressure roller 31 and the conductor 65 to conduct. As a result, the electric charge is less likely to be accumulated in the fixing belt 21 and the pressure roller 31 even after over time.

In the present embodiment, the present disclosure is applied to the fixing device 20 that includes the fixing belt 21 as the fixing rotator, the pressure roller 31 as the pressing rotator, and the planar heater 24 as the heat source. However, the fixing device to which the present disclosure is applied is not limited to this, and the present disclosure can be naturally applied to, for example, a fixing device that includes a heater or an electromagnetic induction coil as the heat source, a fixing device that includes a fixing roller or a fixing belt (which is stretched around a plurality of rollers) as the fixing rotator, and a fixing device that includes a pressure belt as the pressing rotator. In the present embodiment, the conductive elastic layer 21b is used as the conductive layer formed on the fixing belt 21 (fixing rotator). However, the base layer 21a having conductivity may be used as the conductive layer formed on the fixing belt 21 (the fixing rotator). In such a case, the fixing belt 21 may not include the elastic layer, and may include a base layer serving as the conductive layer and an insulating surface layer directly layered on the base layer. Alternatively, the fixing belt 21 (fixing rotator) may be a belt in which an elastic layer having no conductivity and an insulating surface layer are sequentially layered on a base layer having conductivity (i.e., a belt in which an insulating surface layer is indirectly layered on a base layer serving as the conductive layer). In addition, in the present embodiment, a donut-shaped member having conductivity is used as the conductor 65, but the conductor 65 is not limited thereto as long as the conductor 65 is grounded by being electrically connected to the conductive layer (conductive elastic layer 21b) of the fixing rotator (fixing belt 21), and for example, a gear having conductivity may be used as the conductor 65. The above-described configurations also provide similar effects to those of the above-described embodiments and the modifications.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the present embodiments, such as the number, the position, and the shape are not limited the embodiments and thus may be preferably set.

In the present specification, the term “sheet” is defined as any sheet-like recording medium including all conveyed objects, such as typical paper, coated paper, label paper, overhead projector (OHP) transparency, or a film sheet.

Aspects of the present disclosure may be, for example, a combination of the first to eighth aspects as follows.

### First Aspect

A fixing device (e.g., the fixing device 20) includes a fixing rotator (e.g., the fixing belt 21) and a pressing rotator (e.g., the pressure roller 31). The fixing rotator is heated by a heat source (e.g., the planar heater 24). The pressing rotator forms a nip portion to which a sheet (e.g., the sheet P) is conveyed by being pressed against the fixing rotator. The fixing rotator includes a conductive layer (e.g., the conductive elastic layer 21b) and an insulating surface layer (e.g., the insulating surface layer 21c). The conductive layer has conductivity. The insulating surface layer is directly or indirectly laminated on the conductive layer and has an insulating property. The pressing rotator includes a conductive surface layer (e.g., the conductive surface layer 34), a conductor (e.g., the conductor 65), and a conductive roller (e.g., the conductive roller 66). The conductive surface layer contacts the insulating surface layer of the fixing rotator to form the nip portion and has a conductive property. The conductor is electrically connected to the conductive layer of the fixing rotator and is grounded. The conductive roller contacts the conductive surface layer of the pressing rotator and the conductor to conduct electricity.

### Second Aspect

In the fixing device (e.g., the fixing device 20) according to the first aspect, the conductor (e.g., the conductor 65) contacts the conductive layer (e.g., the conductive elastic layer 21b) and the conductive surface layer (e.g., the conductive surface layer 34). The conductive roller (e.g., the conductive roller 66) is made of a conductive material at least on a surface of the conductive roller, and contacts the conductor and the conductive surface layer in a straddling manner.

### Third Aspect

In the fixing device (e.g., the fixing device 20) according to the first or second aspect, the conductive roller (e.g., the conductive roller 66) is contactable with and separatable from the conductor (e.g., the conductor 65) and the conductive surface layer (e.g., the conductive surface layer 34).

### Fourth Aspect

In the fixing device (e.g., the fixing device 20) according to the third aspect, the conductive roller (e.g., the conductive roller 66) contacts the conductor (e.g., the conductor 65) and the conductive surface layer (e.g., the conductive surface layer 34) during a fixing process, and is separated from the conductor and the conductive surface layer during a non-fixing process.

### Fifth Aspect

In the fixing device (e.g., the fixing device 20) according to the third aspect, the conductive roller (e.g., the conductive roller 66) contacts the conductor (e.g., the conductor 65) and the conductive surface layer (e.g., the conductive surface layer 34) when the sheets (e.g., the sheet P) are continuously conveyed to the nip portion and when the number of sheets continuously conveyed per unit time exceeds a specified number (e.g., the specified number A). The conductive roller is separated from the conductor and the conductive surface layer when the number of sheets continuously conveyed per unit time does not exceed the specified number of sheets when the number of sheets continuously conveyed per unit time exceeds the specified number.

### Sixth Aspect

In the fixing device (e.g., the fixing device 20) according to any one of the first to fifth aspects, the conductive roller (e.g., the conductive roller 66) contacts the conductor (e.g., the conductor 65) and the conductive surface layer (e.g., the conductive surface layer 34) outside a maximum sheet conveyance region (e.g., the maximum sheet conveyance region M).

### Seventh Aspect

In the fixing device (e.g., the fixing device 20) according to any one of the first to sixth aspects, the conductive roller (e.g., the conductive roller 66) contacts the conductor (e.g., the conductor 65) and the conductive surface layer (e.g., the conductive surface layer 34) at a position where the conductive roller does not protrude outward in a width direction with respect to the conductor.

### Eighth Aspect

An image forming apparatus (e.g., the image forming apparatus 100) includes the fixing device (e.g., the fixing device 20) according to any one of the first to seventh aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A fixing device comprising:
a fixing rotator including a heat source in the fixing rotator;
a pressing rotator pressed against the fixing rotator to form a nip portion between the pressing rotator and the fixing rotator to perform a fixing process; and
a conductive roller having conductivity and contacting the pressing rotator,
wherein the fixing rotator includes:
a first conductive layer having conductivity; and
an insulating layer on the first conductive layer, the insulating layer having insulating property,
the pressing rotator includes:
a second conductive layer having conductivity, the second conductive layer contacting the insulating layer of the fixing rotator to form the nip portion; and
a conductor grounded and electrically connected to the first conductive layer of the fixing rotator, and
the conductive roller contacts each of the second conductive layer and the conductor to electrically connect the second conductive layer and the conductor.

2. The fixing device according to claim 1,
wherein the conductor contacts the first conductive layer of the fixing rotator and the second conductive layer of the pressing rotator,
the conductor is adjacent to the second conductive layer in an axial direction of the pressing rotator, and
the conductive roller has a conductive surface across the conductor and the second conductive layer.

3. The fixing device according to claim 1,
wherein the conductive roller is separately contactable with the conductor and the second conductive layer.

4. The fixing device according to claim 3, further comprising circuitry configured to:
cause the conductive roller to contact the conductor and the second conductive layer during performing the fixing process; and
cause the conductive roller to be separated from the conductor and the second conductive layer during a time other than the fixing process.

5. The fixing device according to claim 3,, further comprising circuitry configured to cause the conductive roller to contact with or separated from the conductor and the second conductive layer,
wherein the pressing rotator forms the nip portion with the fixing rotator to continuously convey multiple sheets,
the circuitry is further configured to:
cause the conductive roller to contact the conductor and the second conductive layer when a number of the sheets continuously conveyed per unit time exceeds a specified number; and
cause the conductive roller to be separated from the conductor and the second conductive layer when the number of the sheets continuously conveyed per unit time is within the specified number.

6. The fixing device according to claim 1,
wherein the pressing rotator forms the nip portion with the fixing rotator to convey a sheet having a width within a maximum sheet conveyance region in an axial direction of the pressing rotator, and
the conductive roller contacts the conductor and the second conductive layer in a region outside the maximum sheet conveyance region in the axial direction.

7. The fixing device according to claim 1,
wherein the conductive roller has an outer end disposed inside an outer end of the conductor in an axial direction of the pressing rotator.

8. An image forming apparatus comprising:
a process cartridge to form an image on a sheet; and
the fixing device according to claim 1 to fix the image formed on the sheet by the process cartridge.
